(19) United States
(12) Patent Application Publication
(10) Pub. No.: US 2024/0015509 A1
(43) Pub. Date: Jan. 11, 2024

(54) Dynamic tokens for allowing guests to access a wi-fi network

(71) Applicant: Plume Design, Inc., Palo Alto, CA (US)

(72) Inventors: Dariusz Kopka, Warsaw (PL); William McFarland, Portola Valley, CA (US)

(21) Appl. No.: 17/859,625

(22) Filed: Jul. 7, 2022

(51) Int. Cl. H04W 12/08; H04W 12/069; H04W 12/63; G06K 7/14; G06K 19/06

(52) U.S. Cl. CPC H04W 12/08; H04W 12/069; H04W 12/63; G06K 7/1417; G06K 19/06037; H04W 84/12

(57) ABSTRACT

Systems and methods for controlling Wi-Fi access are provided. A method for controlling Wi-Fi access, according to one implementations, includes receiving a request for access by a guest device to a host Wi-Fi network, wherein the request is in response to a predefined event related to a guest associated with the guest device, and providing an access code to one or more of the guest device and the host Wi-Fi network in response to the request, the access code enabling the guest device to access the host Wi-Fi network and defines access limits and restrictions.

### FIELD OF THE DISCLOSURE

The present disclosure generally relates to wireless networking systems and methods. More particularly, the present disclosure relates to systems and methods for providing tokens, such as a QR code, for allowing a guest to temporarily access a Wi-Fi network when a guest device is within a certain area.

### BACKGROUND OF THE DISCLOSURE

Wi-Fi networks (i.e., Wireless Local Area Networks (WLAN) based on the IEEE 802.11 standards) are ubiquitous. In fact, Wi-Fi is the most common technique for user device connectivity, and the applications that use run over Wi-Fi are continually expanding. For example, Wi-Fi is used to carry all sorts of media, including video traffic, audio traffic, telephone calls, video conferencing, online gaming, and security camera video. Often traditional data services are also simultaneously in use, such as web browsing, file upload/download, disk drive backups, and any number of mobile device applications. That is, Wi-Fi has become the primary connection between user devices and the Internet in the home or other locations. The vast majority of connected devices use Wi-Fi for their primary network connectivity. As such, there is a need to ensure applications run smoothly over Wi-Fi. There are various optimization techniques for adjusting network operating parameters such as described in commonly assigned U.S. patent application Ser. No. 16/032,584, filed Jul. 11, 2018, and entitled “Optimization of distributed Wi-Fi networks,” the contents of which are incorporated by reference herein.

Wi-Fi is continuing to evolve with newer generations of technology, including IEEE 802.11a, 802.11b, 802.11g, 802.11n, 802.11ac, and 802.11ax (referred to as Wi-Fi 6/6E). Each generation of technology evolves the Wi-Fi Media Access Control (MAC) and Physical (PHY) layers to add more capabilities. In the case of IEEE 802.11ax, Orthogonal Frequency-Division Multiple Access (OFDMA) has been added as a technique aimed at improving the efficiency of Wi-Fi communication when many small packets are being transmitted to or from multiple client devices. OFDMA can operate both in the downlink (one access point communicating simultaneously to multiple clients), or in the uplink (multiple clients communicating simultaneously to a single access point).

Not only is Wi-Fi available in a home setting, but Wi-Fi is often available is certain public places as well, such as coffee shops, airports, waiting areas, libraries, etc. Usually, a user may access the public Wi-Fi network using the “name” of the Wi-Fi network, or Service Set Identifier (SSID), and a password, which may be provided to the user in some fashion. For example, in a coffee shop setting, a sign may be set up that shows the name of the Wi-Fi network (e.g., “MainStreetCoffee”) and a password (e.g., “coffee123”) for use by its customers. In this case, the customers can copy the SSID and password and then enter this information in a “network settings” application of their respective electronic devices (e.g., laptops, phones, etc.) to gain access to the Internet via this Wi-Fi network. One issue with this process is that it can initially be a bit confusing for some people who are not familiar with entering new network information into their devices.

Nevertheless, after entering the credentials to gain access to this Wi-Fi network, the customer can usually access this same Wi-Fi network any time he or she visits the coffee shop. However, another issue is that the Wi-Fi network can also be accessed even when the person is anywhere in the vicinity of the coffee shop and does not necessarily need to enter the coffee shop, at times, to gain access. Still referring the coffee shop example, some people may be able to use the Wi-Fi network without ever making a purchase or may make a small purchase in the morning and then stay all day on his or her computer. Of course, many of these scenarios are usually not what a coffee shop owner might have planned, but instead the owner probably intended that Wi-Fi access be offered to paying customers as a complimentary service. Offering free Wi-Fi to too many non-paying users may not be a good business model and may lead to latency or other issues for the actual customers if too many users are online at once. Also, the credentials for gaining Wi-Fi access are typically static. That is, the coffee shop owner or employees may rarely change the SSID and password and thus the credentials can be shared too easily.

Often, the SSID may include a Pre-Shared Key (PSK) for Wi-Fi encryption and used with some form of a password and shared by users to secure Wi-Fi traffic. Also, the SSID may simultaneously support a number of configured PSKs, which can be used for allowing a user to join the network. Thus, for security purposes, multi-PSK features can be used. Also, multi-PSK in conjunction with OpenFlow rules can build logical sections of the network. However, multi-PSKs normally do not scale up well.

Also, sharing, updating, and distributing unique passwords usually requires logistics. Therefore, in some cases, in place of SSIDs and passwords, a scannable code (e.g., Quick Response (QR) code) may be printed out and displayed for customers to scan. These codes can include the credentials for allowing a user to access the Wi-Fi network. However, again, these access codes are usually not changed and can therefore be too easily shared. Enterprise solutions may be more suitable for this use-case, but there is no standard QR code format supported by mobile phones to share more complex SSID and password combinations. Also, with access codes freely displayed for any person to scan, user devices are not uniquely identified since anyone possessing these credentials can connect to the Wi-Fi network.

Therefore, there is a need in the field of Wi-Fi systems to overcome the deficiencies of the conventional systems and provide an easy process for enabling a user to access Wi-Fi network, while at the same time placing limitations on customer access in order to prevent abuse of such complimentary services.

### BRIEF SUMMARY OF THE DISCLOSURE

The present disclosure relates to systems and methods for limiting Wi-Fi access for a guest. An apparatus, according to one implementation, includes a processor and memory configured to store instructions. When executed, the instructions enable the processor to receive a request for access by a guest device to a host Wi-Fi network, wherein the request is in response to a predefined event related to a guest associated with the guest device. The access code, for example, enables the guest device to access a host Wi-Fi system. The processor can further provide an access code to one or more of the guest device and the host Wi-Fi network in response to the request, the access code enabling the guest device to access the host Wi-Fi network and defines access limits and restrictions.

In some embodiments, the instructions may further enable the processor to receive the predefined restrictions from a host associated with the host Wi-Fi system. For example, the predefined restrictions may limit a time limit for the guest based on parameters of the predefined event. The predefined restrictions may further limit the guest based on one or more predefined events, such as a) specific requests received from the guest and b) specific financial transactions associated with the guest.

The predefined event may include a) the host making a command on behalf of the guest, b) the guest making a request when the host Wi-Fi system is a publicly accessible network, c) the guest providing service subscription information, d) the guest providing membership information, e) the guest making a purchase, and/or other events. Also, the instructions may further enable the processor to store purchase information associated with the purchase.

The action of providing the access code may include, according to some embodiments, a Quick Response (QR) code to be scanned by the guest device. According to various embodiments, the QR code may be presented on one or more of a closed-circuit television screen, a dedicated display device associated with a Point-of-Sale (POS) device, an electronic device associated with a host of the host Wi-Fi system, and a receipt.

The predefined event described above may be a purchase using Near Field Communication (NFC) protocols. The action of providing the access code may include, for example, the step of automatically communicating the access code to the guest device during the NFC purchase. The instructions may further enable the processor to limit locations where the guest device can access the host Wi-Fi system.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of various Wi-Fi network topologies for connectivity to the Internet

FIG. 2 is a network diagram of the Wi-Fi network 10 with cloud-based control.

FIG. 3 is a block diagram of functional components of the access points, mesh nodes, repeaters, etc. in the Wi-Fi networks of FIG. 1.

FIG. 4 is a block diagram of functional components of a server, a Wi-Fi client device, or a user device that may be used with the Wi-Fi network of FIG. 1 and/or the cloud-based control of FIG. 3.

FIG. 5 is a diagram of a Wi-Fi system configured for limiting access that a guest may access a host Wi-Fi network.

FIG. 6 is a block diagram of the Wi-Fi access control device shown in FIG. 5.

FIGS. 7A-7E are diagrams of examples of media on which a QR code can be displayed.

FIG. 8 is a flow diagram illustrating a process for limiting guest access of a host Wi-Fi network.

### DETAILED DESCRIPTION OF THE DISCLOSURE

Again, the present disclosure relates to systems and methods for placing restrictions or limitations on the availability of Wi-Fi access for a guest using a host Wi-Fi network. In some embodiments, the systems and methods may include providing an access code, such as a Quick Response (QR) code, to a guest device. The access code may be provided in response to a predefined event related to a guest associated with the guest device. For example, this access code is configured to enable the guest device to access a host Wi-Fi system. In response to the guest device using the access code to obtain access to the host Wi-Fi system, the Wi-Fi access control devices may be configured to automatically limit at least the time when the guest device can continue to access the host Wi-Fi system based on predefined restrictions.

### Wi-Fi Network Topologies

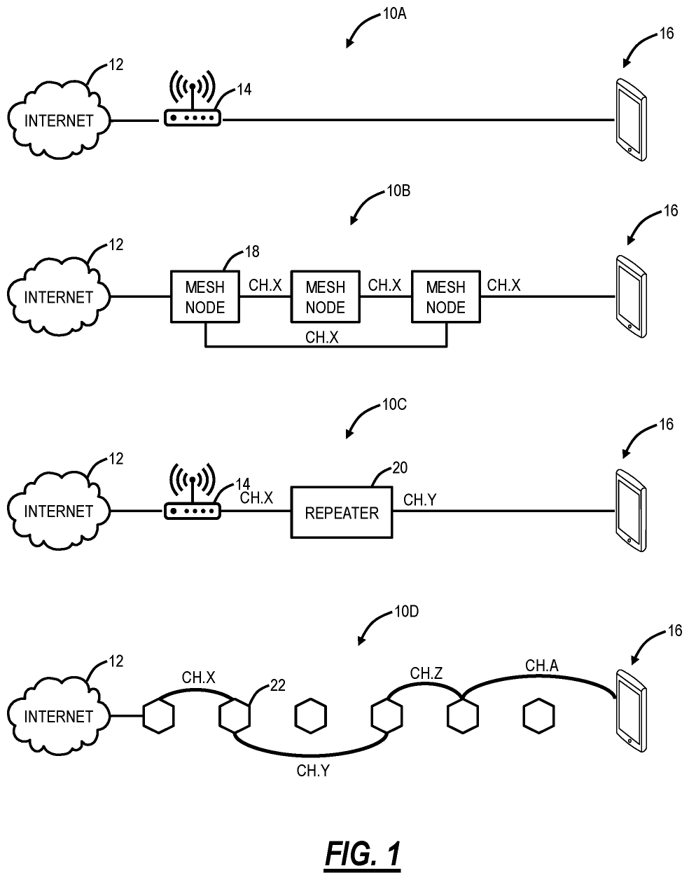

FIG. 1 is a network diagram of various Wi-Fi network 10 (namely Wi-Fi networks 10A-10D) topologies for connectivity to the Internet 12. The Wi-Fi network 10 can operate in accordance with the IEEE 802.11 protocols and variations thereof. The Wi-Fi network 10 is deployed to provide coverage in a physical location, e.g., home, business, store, library, school, park, etc. The differences in the topologies of the Wi-Fi networks 10 are that they provide different scope of physical coverage. As described herein and as known in the art, the Wi-Fi network 10 can be referred to as a network, a system, a Wi-Fi network, a Wi-Fi system, a cloud-based Wi-Fi system, etc. The access points 14 and equivalent (i.e., mesh nodes 18, repeater 20, and devices 22) can be referred to as nodes, access points, Wi-Fi nodes, Wi-Fi access points, etc. The objective of the nodes is to provide network connectivity to Wi-Fi client devices 16 which can be referred to as client devices, user equipment, user devices, clients, Wi-Fi clients, Wi-Fi devices, etc. Note, those skilled in the art will recognize the Wi-Fi client devices 16 can be mobile devices, tablets, computers, consumer electronics, home entertainment devices, televisions, Internet of Things (IoT) devices, or any network-enabled device.

The Wi-Fi network 10A includes a single access point 14, which can be a single, high-powered access point 14, which may be centrally located to serve all Wi-Fi client devices 16 in a location. Of course, a typical location can have several walls, floors, etc. between the single access point 14 and the Wi-Fi client devices 16. Plus, the single access point 14 operates on a single channel (or possible multiple channels with multiple radios), leading to potential interference from neighboring systems. The Wi-Fi network 10B is a Wi-Fi mesh network that solves some of the issues with the single access point 14 by having multiple mesh nodes 18, which distribute the Wi-Fi coverage. Specifically, the Wi-Fi network operates based on the mesh nodes 18 being fully interconnected with one another, sharing a channel such as a channel X between each of the mesh nodes 18 and the Wi-Fi client device 16. That is, the Wi-Fi network 10B is a fully interconnected grid, sharing the same channel, and allowing multiple different paths between the mesh nodes 18 and the Wi-Fi client device 16. However, since the Wi-Fi network 10B uses the same backhaul channel, every hop between source points divides the network capacity by the number of hops taken to deliver the data. For example, if it takes three hops to stream a video to a Wi-Fi client device 16, the Wi-Fi network 10B is left with only ⅓ the capacity.

The Wi-Fi network 10C includes the access point 14 coupled wirelessly to a Wi-Fi repeater 20. The Wi-Fi network 10C with the repeaters 20 is a star topology where there is at most one Wi-Fi repeater 20 between the access point 14 and the Wi-Fi client device 16. From a channel perspective, the access point 14 can communicate to the Wi-Fi repeater 20 on a first channel, Ch. X, and the Wi-Fi repeater 20 can communicate to the Wi-Fi client device 16 on a second channel, Ch. Y. The Wi-Fi network 10C solves the problem with the Wi-Fi mesh network of requiring the same channel for all connections by using a different channel or band for the various hops (note, some hops may use the same channel/band, but it is not required), to prevent slowing down the Wi-Fi speed. One disadvantage of the repeater 20 is that it may have a different service set identifier (SSID), from the access point 14, i.e., effectively different Wi-Fi networks from the perspective of the Wi-Fi client devices 16.

Despite Wi-Fi's popularity and ubiquity, many consumers still experience difficulties with Wi-Fi. The challenges of supplying real-time media applications, like those listed above, put increasing demands on the throughput, latency, jitter, and robustness of Wi-Fi. Studies have shown that broadband access to the Internet through service providers is up 99.9% of the time at high data rates. However, despite the Internet arriving reliably and fast to the edge of consumer's homes, simply distributing the connection across the home via Wi-Fi is much less reliable leading to poor user experience.

Several issues prevent conventional Wi-Fi systems from performing well, including i) interference, ii) congestion, and iii) coverage. For interference, with the growth of Wi-Fi has come the growth of interference between different Wi-Fi networks which overlap. When two networks within range of each other carry high levels of traffic, they interfere with each other, reducing the throughput that either network can achieve. For congestion, within a single Wi-Fi network, there may be several communications sessions running. When several demanding applications are running, such as high-definition video streams, the network can become saturated, leaving insufficient capacity to support the video streams.

For coverage, Wi-Fi signals attenuate with distance and when traveling through walls and other objects. In many environments, such as residences, reliable Wi-Fi service cannot be obtained in all rooms. Even if a basic connection can be obtained in all rooms, many of those locations will have poor performance due to a weak Wi-Fi signal. Various objects in a residence such as walls, doors, mirrors, people, and general clutter all interfere and attenuate Wi-Fi signals leading to slower data rates.

Two general approaches have been tried to improve the performance of conventional Wi-Fi systems, as illustrated in the Wi-Fi networks 1A, 10B, 10C. The first approach (the Wi-Fi network 10A) is to simply build more powerful single access points, in an attempt to cover a location with stronger signal strengths, thereby providing more complete coverage and higher data rates at a given location. However, this approach is limited by both regulatory limits on the allowed transmit power, and by the fundamental laws of nature. The difficulty of making such a powerful access point, whether by increasing the power, or increasing the number of transmit and receive antennas, grows exponentially with the achieved improvement. Practical improvements using these techniques lie in the range of 6 to 12 dB. However, a single additional wall can attenuate by 12 dB. Therefore, despite the huge difficulty and expense to gain 12 dB of the link budget, the resulting system may not be able to transmit through even one additional wall. Any coverage holes that may have existed will still be present, devices that suffer poor throughput will still achieve relatively poor throughput, and the overall system capacity will be only modestly improved. In addition, this approach does nothing to improve the situation with interference and congestion. In fact, by increasing the transmit power, the amount of interference between networks actually goes up.

A second approach is to use repeaters or a mesh of Wi-Fi devices to repeat the Wi-Fi data throughout a location, as illustrated in the Wi-Fi networks 10B, 10C. This approach is a fundamentally better approach to achieving better coverage. By placing even a single repeater 20 in the center of a house, the distance that a single Wi-Fi transmission must traverse can be cut in half, halving also the number of walls that each hop of the Wi-Fi signal must traverse. This can make a change in the link budget of 40 dB or more, a huge change compared to the 6 to 12 dB type improvements that can be obtained by enhancing a single access point as described above. Mesh networks have similar properties as systems using Wi-Fi repeaters 20. A fully interconnected mesh adds the ability for all the mesh nodes 18 to be able to communicate with each other, opening the possibility of packets being delivered via multiple hops following an arbitrary pathway through the network.

The Wi-Fi network 10D includes various Wi-Fi devices 22 that can be interconnected to one another wirelessly (Wi-Fi wireless backhaul links) or wired, in a tree topology where there is one path between the Wi-Fi client device 16 and the gateway (the Wi-Fi device 22 connected to the Internet), but which allows for multiple wireless hops unlike the Wi-Fi repeater network and multiple channels unlike the Wi-Fi mesh network. For example, the Wi-Fi network 10D can use different channels/bands between Wi-Fi devices 22 and between the Wi-Fi client device 16 (e.g., Ch. X, Y, Z, A), and, also, the Wi-Fi system 10 does not necessarily use every Wi-Fi device 22, based on configuration and optimization. The Wi-Fi network 10D is not constrained to a star topology as in the Wi-Fi repeater network which at most allows two wireless hops between the Wi-Fi client device 16 and a gateway. Wi-Fi is a shared, simplex protocol meaning only one conversation between two devices can occur in the network at any given time, and if one device is talking the others need to be listening. By using different Wi-Fi channels, multiple simultaneous conversations can happen simultaneously in the Wi-Fi network 10D. By selecting different Wi-Fi channels between the Wi-Fi devices 22, interference and congestion can be avoided or minimized.

Of note, the systems and methods described herein contemplate operation through any of the Wi-Fi networks 10, including other topologies not explicated described herein. Also, if there are certain aspects of the systems and methods which require multiple nodes in the Wi-Fi network 10, this would exclude the Wi-Fi network 10A.

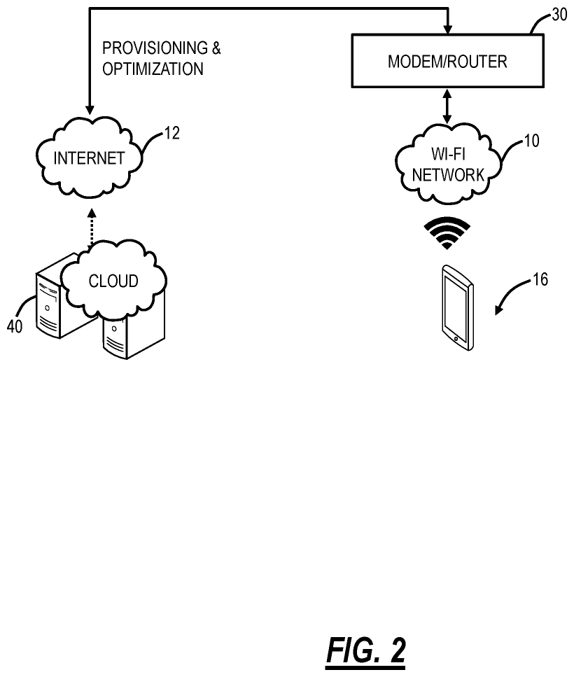

FIG. 2 is a network diagram of the Wi-Fi network 10 with cloud-based control. The Wi-Fi network 10 includes a gateway device which is any of the access points 14, the mesh node 18, or the Wi-Fi device 22 that connects to a modem/router 30 that is connected to the Internet 12. For external network connectivity, the modem/router 18 which can be a cable modem, Digital Subscriber Loop (DSL) modem, cellular interface, or any device providing external network connectivity to the physical location associated with the Wi-Fi network 10. In an embodiment, the Wi-Fi network 10 can include centralized control such as via a cloud service 40 located on the Internet 12 and configured to control multiple Wi-Fi networks 10. The cloud service 40 can receive measurement data, analyze the measurement data, and configure the nodes in the Wi-Fi network 10 based thereon. This cloud-based control is contrasted with a conventional operation that relies on a local configuration such as by logging in locally to an access point.

### Access Point

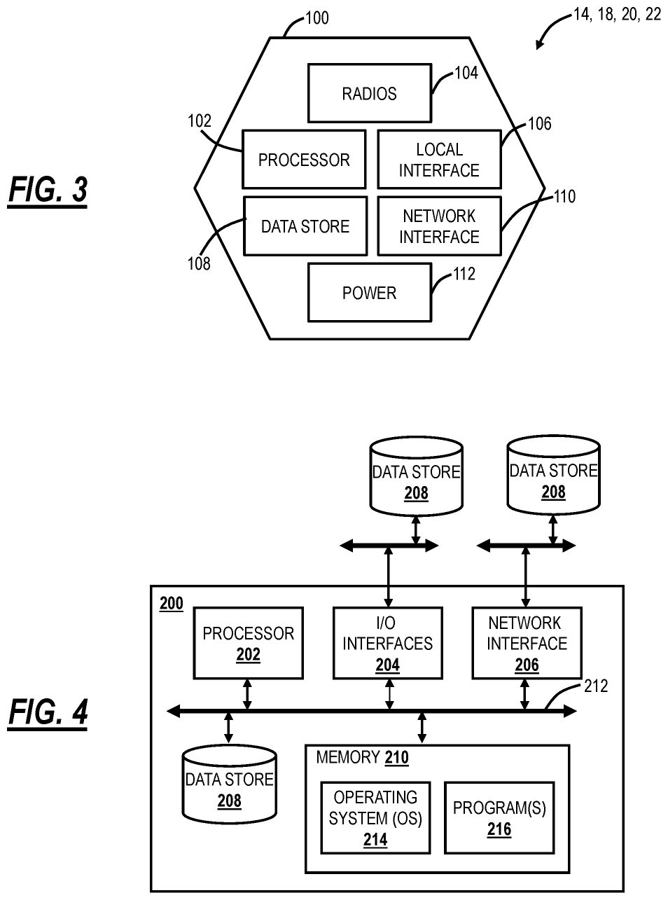

FIG. 3 is a block diagram of functional components of the access points 14, mesh nodes 18, repeaters 20, etc. (“node”) in the Wi-Fi networks 10. The node includes a physical form factor 100 which contains a processor 102, a plurality of radios 104, a local interface 106, a data store 108, a network interface 110, and power 112. It should be appreciated by those of ordinary skill in the art that FIG. 3 depicts the node in an oversimplified manner, and a practical embodiment may include additional components and suitably configured processing logic to support features described herein or known or conventional operating features that are not described in detail herein.

In an embodiment, the form factor 100 is a compact physical implementation where the node directly plugs into an electrical socket and is physically supported by the electrical plug connected to the electrical socket. This compact physical implementation is ideal for a large number of nodes distributed throughout a residence. The processor 102 is a hardware device for executing software instructions. The processor 102 can be any custom made or commercially available processor, a central processing unit (CPU), an auxiliary processor among several processors, a semiconductor-based microprocessor (in the form of a microchip or chipset), or generally any device for executing software instructions. When the node is in operation, the processor 102 is configured to execute software stored within memory or the data store 108, to communicate data to and from the memory or the data store 108, and to generally control operations of the access point 14 pursuant to the software instructions. In an embodiment, the processor 102 may include a mobile optimized processor such as optimized for power consumption and mobile applications.

The radios 104 enable wireless communication in the Wi-Fi network 10. The radios 104 can operate according to the IEEE 802.11 standard. The radios 104 include address, control, and/or data connections to enable appropriate communications on the Wi-Fi network 10. As described herein, the node can include a plurality of radios to support different links, i.e., backhaul links and client links. The radios 104 can also include Wi-Fi chipsets configured to perform IEEE 802.11 operations. In an embodiment, an optimization can determine the configuration of the radios 104 such as bandwidth, channels, topology, etc. In an embodiment, the node supports dual-band operation simultaneously operating 2.4 GHz and 5 GHz 2×2 MIMO 802.11b/g/n/ac radios having operating bandwidths of 20/40 Mhz for 2.4 GHz and 20/40/80 MHz for 5 GHz. For example, the node can support IEEE 802.11AC1200 gigabit Wi-Fi (300+867 Mbps). Also, the node can support additional frequency bands such as 6 GHz, as well as cellular connections.

The local interface 106 is configured for local communication to the node and can be either a wired connection or wireless connection such as Bluetooth or the like. Since the node can be configured via the cloud service 40, an onboarding process is required to first establish connectivity for a newly turned on node. In an embodiment, the node can also include the local interface 106 allowing connectivity to a Wi-Fi client device 16 for onboarding to the Wi-Fi network 10 such as through an app on the user device 22. The data store 108 is used to store data. The data store 108 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 108 may incorporate electronic, magnetic, optical, and/or other types of storage media.

The network interface 110 provides wired connectivity to the node. The network interface 104 may be used to enable the node communicates to the modem/router 30. Also, the network interface 104 can be used to provide local connectivity to a Wi-Fi client device 16. For example, wiring in a device to a node can provide network access to a device that does not support Wi-Fi. In an embodiment, all of the nodes in the Wi-Fi network 10 include the network interface 110. In another embodiment, select nodes, which connect to the modem/router 30 or require local wired connections have the network interface 110. The network interface 110 may include, for example, an Ethernet card or adapter (e.g., 10BaseT, Fast Ethernet, Gigabit Ethernet, 10GbE). The network interface 110 may include address, control, and/or data connections to enable appropriate communications on the network.

The processor 102 and the data store 108 can include software and/or firmware which essentially controls the operation of the node, data gathering and measurement control, data management, memory management, and communication and control interfaces with the cloud service 40. The processor 102 and the data store 108 may be configured to implement the various processes, algorithms, methods, techniques, etc. described herein.

### Cloud Server and User Device

FIG. 4 is a block diagram of functional components of a server 200, a Wi-Fi client device, or a user device that may be used with the Wi-Fi network of FIG. 1 and/or the cloud-based control of FIG. 3. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 4 depicts the server 200 in an oversimplified manner, and a practical embodiment may include additional components and suitably configured processing logic to support features described herein or known or conventional operating features that are not described in detail herein.

The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a central processing unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components. The user input may be provided via, for example, a keyboard, touchpad, and/or a mouse. System output may be provided via a display device and a printer (not shown). I/O interfaces 204 may include, for example, a serial port, a parallel port, a small computer system interface (SCSI), a serial ATA (SATA), a fiber channel, InfiniBand, iSCSI, a PCI Express interface (PCI-x), an infrared (IR) interface, a radio frequency (RF) interface, and/or a universal serial bus (USB) interface.

The network interface 206 may be used to enable the server 200 to communicate on a network, such as the cloud service 40. The network interface 206 may include, for example, an Ethernet card or adapter (e.g., 10BaseT, Fast Ethernet, Gigabit Ethernet, or a wireless local area network (WLAN) card or adapter (e.g., 802.11a/b/g/n/ac). The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200 such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable operating system (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein, such as related to the optimization.

### Presenting Dynamic OR Code for Temporary Wi-Fi Network Access

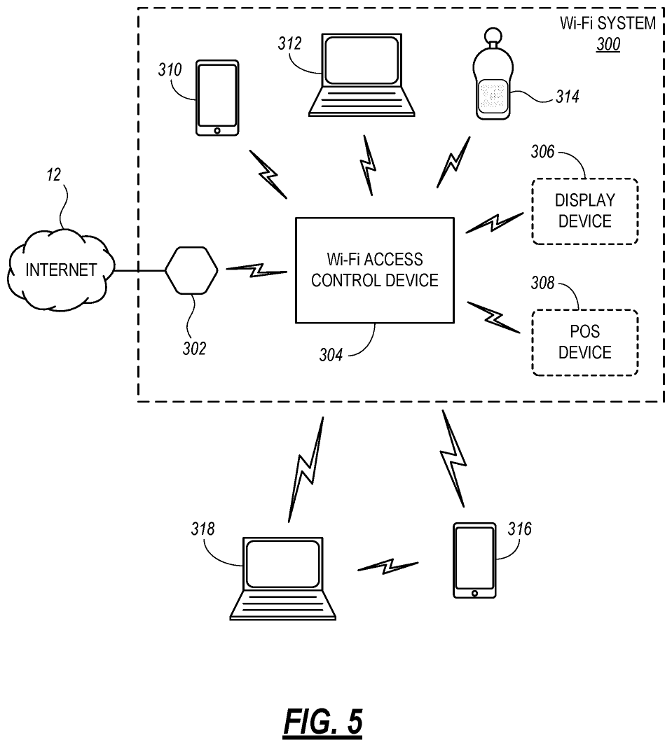

FIG. 5 is a diagram showing an embodiment of a Wi-Fi network 300 configured to limit Wi-Fi access for one or more guests. The Wi-Fi network 300 may include one or more access points 302 (e.g., access points 14) for enabling the Wi-Fi network 300 or other wireless network (e.g., WLAN) to communicate with other devices on the Internet 12. The Wi-Fi network 300 may be any type of wireless network (e.g., wireless network 10A, 10B, 10C, 10D, etc.) for enabling access to a host Wi-Fi network. In this embodiment, “host” devices are defined as those devices that may have access to the Wi-Fi network at any time. Also, “guest” devices are defined as those devices that may be granted temporary access to the Wi-Fi network according to the implementations described in the present disclosure.

The Wi-Fi network 300 includes a Wi-Fi access control device 304 configured to control access to the Wi-Fi network according to the specific rules, parameters, restrictions, limitations, etc. described in the present disclosure. For example, the Wi-Fi access control device 304 may be configured to control the amount of time that a guest device is able to access the Wi-Fi network. In some cases, guests may be granted access for a short period of time (e.g., one or two hours of access with the purchase of a cup of coffee). In other cases, guests may be granted access for longer periods of time (e.g., hotel guests, guests who rent coworking spaces on a monthly basis, guests using conference rooms, etc.). Also, the Wi-Fi access control device 304 may be configured to control the locations where each nearby guest device may access the Wi-Fi network (e.g., an area surrounding the access point 302).

In some embodiments, the Wi-Fi network 300 may include one or more display devices 306, such as a display screen, computer monitor, user interface, or other similar visual presentation device. In particular, the display device 306 may be configured to display a Quick Response (QR) code thereon for any suitable length of time. For example, the Wi-Fi access control device 304 may be configured to display a unique QR code on the display device 306 for about 15 seconds. Then, the guest may be able to use his or her mobile device to scan the QR code when it is displayed. The Wi-Fi access information encrypted in the QR code can then be used by the guest device to access the Wi-Fi network. In other embodiments, other suitable types of access codes other than QR codes may be displayed on the display device 306, such as a barcode, Universal Product Code (UPC), etc.

Also, according to some embodiments, the Wi-Fi network 300 may include one or more Point-of-Sale (POS) devices 308. The Wi-Fi access control device 304 may be configured to obtain purchase information from the POS device 308 and process this information to determine if a customer is to be given an access code (e.g., QR code, barcode, etc.) to thereby authorize the customer to access the Wi-Fi network. Also, the Wi-Fi access control device 304 may change the conditions of the Wi-Fi access based on the purchase or purchases. For example, if a customer spends up to a certain amount of money, then the customer may be given a short amount of time to access the Wi-Fi network, but if the customer spends more than a certain amount, more time may be granted.

It may be noted that any of the components 302, 304, 306, 308 may be part of the Wi-Fi network 300, depending on different embodiments. For example, in some embodiments, the Wi-Fi network 300 may be configured without the display device 306, but may instead utilize other devices having display capabilities for presenting the QR code, as described in more detail below. Also, any number of the components 302, 304, 306, 308 may be combined or incorporated in one or more units. For example, the access device 302 may include the functionality of the Wi-Fi access control device 304 and may be incorporated in the form factor 100 shown in FIG. 3.

In addition, the Wi-Fi network 300 may include one or more host devices, such as a mobile device 310 (e.g., mobile phone) belonging to a host, a host computer 312, and/or a host key fob 314. In some embodiments, the host key fob 314 may be part of a suitable public key cryptosystem (e.g., RSA SecurID). The key fob 314 may be used in a residential or business environment. The mobile device 310, host computer 312, and/or host key fob 314 may be configured to display a temporary QR code that can be shown to a guest. The guest can then scan the QR code to obtain access code information for initiating a Wi-Fi session with the Wi-Fi network.

The Wi-Fi network 300 may be configured so as to enable the Wi-Fi access control device 304 to communicate (in a wired or wireless manner) one or more access codes (e.g., QR codes) to one or more of the host devices 310, 312, 314, as pre-programmed, to allow the host devices 310, 312, 314 to display the access code on a display screen thereof. The host devices 310, 312, 314 may be configured to display the access code for any suitable length of time, such as a predetermined time configured in the software on any or all of the Wi-Fi access control device 304 and host devices 310, 312, 314. As such, once an access code is displayed on the host device 310, 312, 314, a host (associated with the host device) may show the code to a guest to allow the guest to use his or her scanning device (e.g., mobile phone) to scan the access code, which can thereby automatically enable the scanning device to access the Wi-Fi network.

It may be noted that FIG. 5 illustrates communication between each of the various components 302, 304, 306, 308, 310, 312, 314 that is a “wireless” transmission. However, it should be understood that each transmission link between communicating components may be achieved via wired and/or wireless mechanisms and protocols, and whereby wireless mechanisms and protocols may be Wi-Fi communication, Bluetooth communication, Near Field Communication (NFC), and/or other relatively short range radio communications strategies that may be suitable in a Wi-Fi network.

Also, FIG. 5 further shows a mobile device 316 (e.g., mobile phone) and a laptop 318, which may represent any number and type of suitable “guest” devices. These guest devices 316, 318 may therefore be granted temporary access to the Wi-Fi network that is controlled by the host, network administrator, Wi-Fi network owner, Information Technology (IT) personnel, etc. For example, the mobile device 316 of a guest may be used to scan the QR code presented to the guest. The guest may also use the original scanning device (e.g., mobile device 316) to add additional devices (e.g., laptop 318, tablet, etc.) to create a sub-net for the guest. In this way, the guest may use one or more of his or her personal devices (e.g., cell phones, smart phones, laptop computers, tablets, etc.) to access the Wi-Fi network. The creation of a sub-net may allow the guest's original accessing device to connect to other computing devices (e.g., computers, laptops, tablets, etc.) and/or peripheral devices (e.g., printers, scanners, monitors, fax machines, display devices, televisions, etc.) as may be needed.

The QR code can be used as a proof of access space. Then, the original device that gains access can create the sub-net with other devices. The user access control module 324 may be configured to group devices that were enrolled using some particular token device and created a separate sub-net. For example, a hotel guest can join the network from his or her room and then share the network with other devices (e.g., computer, printer, etc.). In some implementations, the guest may use his or her phone for casting purposes onto a television in the room.

According to some embodiments, the Wi-Fi network 300 may be used in a “community” Wi-Fi network. In this example, the guest may be a subscriber or member of a community network. The guest may scan the QR code the first time he or she is given credentials to get onto the community network. In some case, new QR codes may be provide to the guests in order to periodically refresh the credentials and to maintain contact with the guests. The QR code in some cases may be displayed on a web page or portal that hosts a service. The QR code could be scanned using the guest's mobile phone 316 to initially access the community network or refresh his or her credentials.

The Wi-Fi network 300 may also be associated with various types of public space networks, open Wi-Fi, free access areas, gateways, Wi-Fi Protected Access (WPA) areas, WPA2, service-provider public hotspots, etc. In some cases, service providers (e.g., Spectrum, Comcast, etc.) may provide broadcast access for its customers. The services may be identified by a Service Set Identifier (SSID) and may allow its customers to access the Internet by connecting to any access point 14, 302. In college and university settings, “eduroam” (or “education roaming”) is used as a global wireless community (e.g., using a Remote Authentication Dial-In User Service (RADIUS) server, etc.). Students may be issued an ID, certificate, etc. to connect to eduroam and a QR code may be scanned to get certification information in an initial or orientation procedure for the students.

The Wi-Fi network 300 may therefore be referred to as a QR code token-based system to enable a user to login to the Wi-Fi network without the need to enter a username, SSID, or password, as is usually required in conventional systems. The host presents the QR code to specific guests for authentication and the Wi-Fi network 300 is configured to impose limitations, which can be encrypted in each QR code.

A token or security token, as described in the present disclosure, may be presented to a guest device 316, 318 to gain access to the electronically restricted Wi-Fi network. The token (e.g., QR code) can be used in place of a password and acts like an electronic cryptographic key for gaining access to the Wi-Fi network.

The Wi-Fi network 300 may use any suitable wireless “onboarding” protocols for enabling a user to gain access to (or join) the Wi-Fi network. For example, the Wi-Fi network 300 may use Easy Connect™, also known as Device Provisioning Protocol (DPP), which was introduced by Android. DPP was introduced as an alternative to Wi-Fi Protected Setup (WPS) and involves a simple procedure for onboarding guest devices 316, 318 to the Wi-Fi network without entering a password. In the present disclosure, scanning the QR code may include bootstrapping and authentication procedures using a Uniform Resource Identifier (URI).

In some embodiments, the QR code may be displayed from a web site (e.g., welcome screen, captive portal, etc.) for offering limited access. This can be accessed by a guest device (e.g., phone 316, laptop 318, tablet (not shown), etc.) which has access to the Internet 12 through another means. For example, the guest device may already be online at a hotspot, online through the cellular connection, etc. In this case, the web site might require the guest to enter a username and password or other credentials to get the Wi-Fi network 300 to display the QR code.

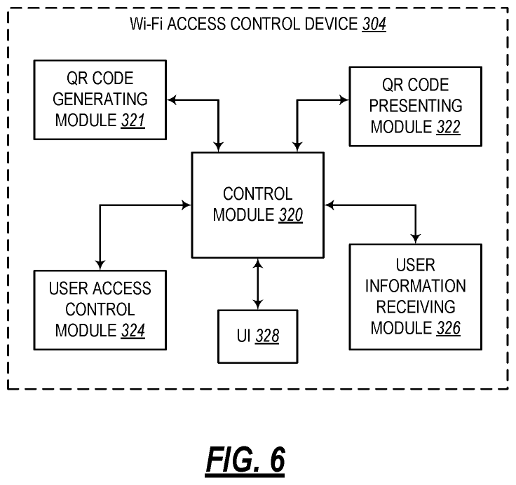

FIG. 6 is a block diagram showing an embodiment of the Wi-Fi access control device 304 shown in FIG. 5. As illustrated in this embodiment, the Wi-Fi access control device 304 may include a control module 320, a QR code generating module 321, a QR code presenting module 322, a user access control module 324, a user information receiving module 326, and/or a User Interface (UI) 328. In some embodiments, the control module 320 and UI 328 may be implemented in hardware, and the modules 321, 322, 324, 326 may be implemented in software. It may be noted that other embodiments of the Wi-Fi access control device 304 are also considered, whereby fewer or more of the modules shown in FIG. 6 may be included in the Wi-Fi access control device 304, depending on various embodiments.

The QR code generating module 321 may be configured to receive instruction from the control module 320 to create a unique QR code for a particular guest. For example, the guest may be offered complimentary Wi-Fi access based on any type of event, such as a purchase of goods or services. In some embodiments, the Wi-Fi network may be accessible to the public (without a specific purchase), such as in certain environments (e.g., airport, library, park, public hotspot, etc.). In other embodiments, a customer may specifically pay for Wi-Fi access, such as a situation where a guest wishes to use the Internet 12 without making a purchase at a coffee shop, café, restaurant, etc., or when a designated time of receiving complimentary Wi-Fi access has expired and the customer wishes to continue with Wi-Fi access.

Furthermore, the QR code generating module 321 may be configured to provide a unique QR code (or other access code) for each individual guest. Therefore, each guest may be given Wi-Fi access based on his or her specific event and conditions. For example, one guest may be given Wi-Fi access for one hour or two hours after purchasing a cup of coffee at a coffee shop. Another guest, for example, may be a hotel guest and may be allowed to access the Wi-Fi network until the designated check-out time.

The QR code presenting module 322 may be configured to communicate with any one or more host device (e.g., host devices 310, 312, 314, etc.) to enable the QR code (generated by the QR code generating module 321) to be presented on the respective host devices. In some embodiments, the QR code presenting module 322 may communicate with the display device 306, which may be dedicated presentation device used exclusively for displaying QR codes for the purpose of granting temporary Wi-Fi access to guests. The modules 321, 322 may be configured to create and present a QR code that changes over time, perhaps quite frequently (e.g., every hour in a coffee shop). In some cases, such as in the hotel room scenario, the QR code may be changed when the old guest checks out of the room and a new guest checks in.

The control module 320 may also be configured to utilize the user access control module 324 to determine limitations or restrictions regarding the offerings of Wi-Fi access to different guests. As mentioned above, user access may be limited by certain time constraints. For example, a purchase at a coffee shop, café, restaurant, etc. may allow a customer to receive one hour of complimentary Wi-Fi time. In some cases, Wi-Fi access time may be offered in proportion to the amount of the purchase, may have a tiered time structure based on ranges of prices paid, or other suitable arrangement. Also, the user access control module 324 may further be configured to based certain limitation on the guest or customer based on location information. For example, if a hotel guest is given Wi-Fi access, the guest may only gain access in the guest's room or in public places (e.g., lobby, dining area, etc., of the hotel).

According to some embodiments, the user information receiving module 326 may be optional or may be omitted in other embodiments. The user information receiving module 326 may be configured to receive information about the customer or guest. For example, the guest information may include identification information (e.g., Media Access Control (MAC) addresses, etc.) about the one or more guest devices 316, 318. The information may also be linked with the specific product and/or service purchased by the customer. In some embodiments, the user information receiving module 326 may be associated with a configured to a captive portal, which may be configured as an introduction webpage that requests or requires specific user information, such as name, email address, phone number, etc., where the user may need to enter some or all of this requested information in order to obtain Wi-Fi access. This information may be used for security purposes, such as in an airport or other public hotspot areas where public access is available.

The UI 328 may be used by the host or other person associated with a hosting entity associated with the hosted Wi-Fi network 300. The UI 328 may allow the control module 320 to receive information (e.g., limitations, restrictions, preferences, etc.) about how Wi-Fi will be offered to guests. The Wi-Fi access control device 304 may also be associated a memory device configured to store the user restrictions and other information regarding Wi-Fi access.

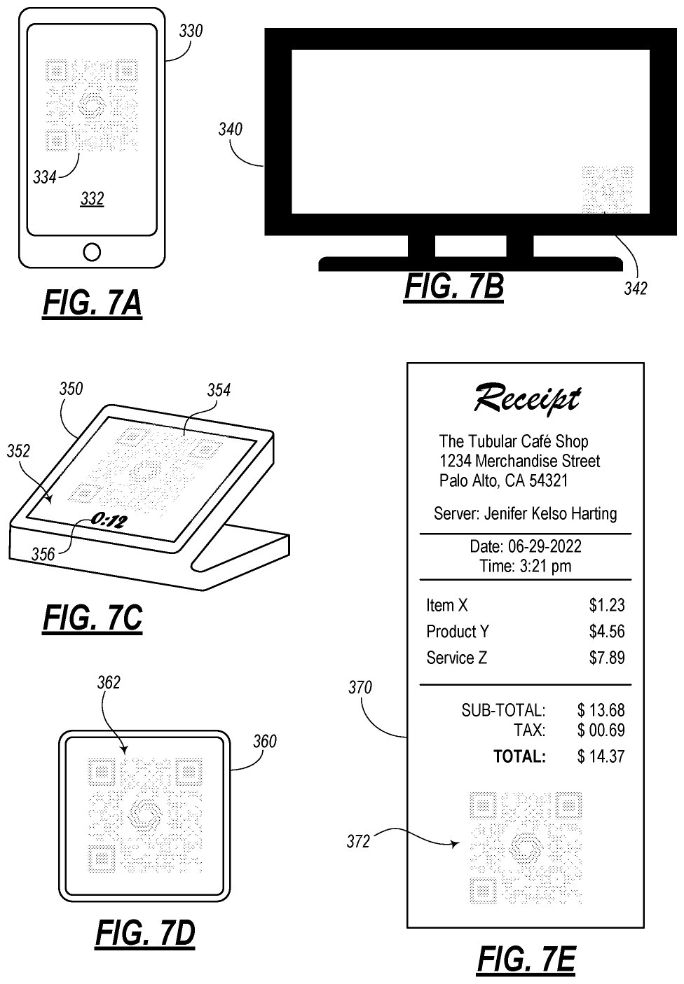

FIGS. 7A-7E show examples of various media on which a QR code can be displayed for offering temporary Wi-Fi access to certain guests. FIG. 7A shows a mobile phone 330, which may be associated with a host. The mobile phone 300 may have a display screen 332 on which a QR code 334 can be presented. The host may then show one or more selected guest that the host wishes to share Wi-Fi access. The guest or guests may then scan the QR code 334, which may cause the Wi-Fi network 300 to automatically set up a temporary Wi-Fi session for the guest or guests, which may be referred to as an “onboarding” process for the guest. It may be noted that the mobile phone 300 may be used in a private residence where a host (e.g., home owner) may offer temporary access to guests (e.g., friends, babysitters, etc.).

FIG. 7B shows a television 340 (or computer monitor) on which a QR code 342 can be displayed. For example, the QR code 342 may be shown using a picture-in-picture function of the television 340. Also, the television 340 may be a closed-circuit television. The television 340, for example, may be located in a hotel room. In some cases, the television 340 may be used in a hotel reservation scenario. For example, when a guest checks in and enters the room, the television 340 display at least the QR code 342 and may also give instructions about how the guest can obtain Wi-Fi access. The guest may use his or her guest device 316 to scan the QR code 342 to automatically receive complimentary Wi-Fi access during the hotel stay (until check-out time). In some embodiments, the television 340 may be a smart TV configured to enable a user to cast a show or movie using a streaming service (e.g., Netflix, Disney Plus, etc.) for display on the television 340. In other implementations, the television 340 may be place in a public area (e.g., an airport, restaurant, lobby of a doctor's office, waiting room at an office or mechanics shop, etc.).

FIG. 7C shows a dedicated display device 350, which may be free-standing device that sits on a countertop, either in a home or in a shop (e.g., near the POS device 308). In some embodiments, the dedicated display device 350 may have a display screen 352 for presenting the QR code 354 to a customer immediately after a purchase is made. Also, the dedicated display device 350 may be incorporated into the POS device 308 shown in FIG. 5 according to some implementations. The dedicated display device 350 may include shielding components (not shown) to allow only the customer to scan the QR code 354 and prevent unauthorized scanning by nearby people trying to get Wi-Fi access without making a purchase.

In some embodiments, the dedicated display device 350 may include a countdown timer 356 that may be started by a cashier, clerk, etc. to allow the customer to access the code within a certain amount of time. Thus, when instructed, the customer can scan the code with his or her phone within the scanning time frame (e.g., 10 seconds, 15 seconds, etc.). The countdown timer 356 shows the remaining time left until the dedicated display device 350 clears the QR code 354 from the display screen 352 to prevent others from scanning the same code intended for the one customer.

FIG. 7D shows an example of a wall-mounted display device 360, which also may be a dedicated device used for the sole purpose of displaying a QR code 362 (or other suitable code) to enable a guest to gain access to the Wi-Fi network. In a public setting (e.g., airport, library, park, etc.), the QR code generating module 321 may be configured to change the QR code 362 on the wall-mounted display device 360 on a regular basis (e.g., once a minute, once every ten minutes, etc.), which may allow the Wi-Fi access control device 304 to keep track of times when a guest may have scanned certain codes. Also, a security system, which may include security cameras and the like, may be used in cooperation with the wall-mounted display device 360 to help identify guests scanning the QR code 362 in the event that such information may be needed (e.g., when potentially illegal activities is detected in the area).

FIG. 7E shows an example of a receipt 370 that may be printed out by a POS device (e.g., POS device 308). In addition to regular purchase information, the POS device 308, QR code presenting module 322, etc. may be configured to print a specific QR code 372. The receipt 370 may also include instructions for the customer regarding how to access the Wi-Fi network using the QR code 372 and certain restrictions (e.g., how much time, location information, etc.) regarding details of the possible Wi-Fi access.

Thus, the QR code can be displayed in numerous ways. A hardware token with Bluetooth can connect to a pod (e.g., access point device) and display the QR code for DPP onboarding. Devices that scan the code can either join the network themselves or can enroll some other device (e.g., laptop). In some embodiments, an API can be used for generating QR codes to be displayed on the television 340, on a phone 310, 330, a laptop 312, a key fob 314, a tablet, etc., which may be used by a network administrator, network operator, home owner, or other host.

Hardware and/or software components (e.g., dedicated components 350, 360, etc. and/or existing equipment 330, 340, etc.) may be used to share QR codes according to the systems and methods of the present disclosure. The QR code may be displayed within an application running on a phone, tablet, or laptop, whereby the application may be the application used to manage the Wi-Fi network. The small, dedicated display devices 350, 360 may be mounted on a wall, placed on a counter top, or positioned in any suitable location for allowing a guest to scan the QR code. These areas may be easily accessible by a guest in a check-in or service counter environment of any type of business. Also, these devices 350, 360 may be shown to the customers when a purchase is made, similar to many POS devices, to ensure that a customer can scan the code when he or she actually buys something. Also, as mentioned throughout the present disclosure, the access code can be a dynamically changing code.

Regarding the onboarding process associated with the television 340 of FIG. 7B, the QR code 342 may be shown on the television 340 that is in a hotel room or other private area intended for one guest or a small group (family) of guests. The guest enters the room with his or her phone and scans QR code 342. Then, the guest device is able to connect to Wi-Fi network using a standard DPP method.

In some embodiments, the guest may wish to use a laptop which does not have a camera for scanning the QR code 342. In this case, the guest enters first uses his or her phone 316 to scan the QR code 342 on the television 340. Then, the computer 318 may be configured to present another QR code on its screen. The access information on the phone 316 can be shared with the laptop 318 over a side channel (e.g., Bluetooth, Wi-Fi Direct, or other peer-to-peer wireless communication or pairing). The laptop 318 can then join the network as well since the phone 316 will be online. The Wi-Fi network 300 may initiate the DPP exchange based on the QR code information that the phone 316 captured off the laptop 318 and moved to the network. According to other scenarios, the television 340 in the hotel room may instead be replaced with a dedicated wall-mounted device.

When using DPP, the Wi-Fi network 300 may use one of the DPP-type modes, where the device attempting to join the network (e.g., guest phone 316) may play the role of both “configurator” and “enrollee.” For example, the guest device can initially access the network using the QR code provided by the display device 306 (or by other devices). Then, the guest device, already connected to the network, can be used to enable other guest devices (e.g., laptop 318, tablet, etc.) to be onboarded using a camera on the guest phone 316. DPP may include the use of bootstrapping security keys to enable the generation of the QR code on demand.

According to additional implementations with respect to the present disclosure, the Wi-Fi network 300 may be configured to use Near-Field Communication (NFC) instead of presenting a QR code (or other access code) to be scanned by a guest device (e.g., mobile phone 316). In this embodiment, an NFC transaction, which may be associated with the POS device 308, can exchange financial information for allowing a customer to make a purchase. At the same time, the POS device 308 may be configured to share access information with the guest phone 316. Therefore, in place of QR code presentation and scanning processes, these steps may instead include the simple NFC connection during a purchase procedure. The cashier or clerk may instruct the customer about the Wi-Fi access information according to various business policies and/or may offer the complimentary Wi-Fi service for a temporary timeframe as an option if the customer so chooses. An advantage of NFC in this example is that this communication strategy is done at a very short distance and will prevent others from “stealing” the free Wi-Fi access. One difference in the two systems is that the QR code scanning procedure requires that the guest device includes a camera for scanning and that the NFC procedure requires NFC reading capabilities on both the POS device 308 and guest phone 316. Also, NFC includes two-way communication, which may enhance security that authenticates both parties.

As part of the QR onboarding process, a certificate or identifier may be loaded onto the guest device, which may limit the QR code to only that device. The process may also form a unique identifier that can help with MAC randomization or otherwise can enable identification of a specific device each time it returns to the network. Each QR code can establish a unique security key (e.g., PSK key), and the unique security key can be used as the identifier (e.g., in a non-DPP approach). This way of onboarding the device allows the network to clearly identify the device for various connections, even if the device chooses to randomize its MAC address.

The credentials supplied by the QR code include the following restrictions or limitations for the user. For example, there may be a time restriction (e.g., one hour, two hours, one day, etc.) that a guest may be able to connect using that credential. The Wi-Fi network 300 may revoke access for all devices in a group after a defined period of time (e.g., if bound to a hotel reservation system and after check-out or when the reservation expires). There may also be a restriction with respect to the physical area over which the guest can access the network, which may be bound by a network of hotspots. However, the guest may be restricted to the hotspots near where he or she scanned the QR code. For example, the guest may scan the code in one airport and have access there, but then will not have access at a next airport unless he or she scans a QR code at that next airport. The QR token can therefore be assigned to some restricted access space (e.g., within a hotel room).

The QR code may also include an indication of what channel where the guest should look for the access point. Since the QR code may be generated on demand in some cases, a channel list can be updated with what is in the network. In particular, if a network is re-optimized nightly, or on the fly due to interference or other need, the QR code following the re-optimization can include a channel list that correctly matches what is currently in the network.

Also, once one guest device (phone) gets provisioned it can be treated as a token itself—providing proof of possession—and literally building ‘chain of trust’ for every device onboarded by this initial guest device (phone).

With respect to various implementations in which a guest device is to be onboarded into a Wi-Fi network having multiple access points, credentials from the QR code may be installed across all access points in a given network, such that the guest device can onboard onto whatever access point it chooses, which potentially may be the nearest access point. The distribution of the credentials from the QR code may be distributed to each access point in this example via the cloud or Internet 12.

In the case that multiple access points are on the same channel, with the same credentials from the same QR codes, the Wi-Fi access control device 304 may be configured to coordinate the access points, either directly or in a daisy-chain manner, in a mesh type manner, through the cloud, etc. This allows each access point to respond to an attempt to onboard by a guest, which may prevent onboarding failures due to chaos caused by multiple access points responding to the same onboarding attempt.

In cases when connection to the Internet 12 is down, moving the onboarding information to the cloud from the app may be implemented via the cellular network. Then, holding and downloading the onboarding information may be performed when the cloud connection comes back up.

Another case may include establishing the access point as initiator of the connection to the guest. This allows one particular access point in a multi-AP network to be selected by the system (e.g., cloud or local controller) to be the one to contact the device and onboard it.

Furthermore, the embodiments of the present disclosure may also include special consideration for “pre-onboarding” or “zero touch” onboarding processes. For example, at the time when a customer purchases an access point device or the like, the vendor may know, based on account information, which network the customer owns. The Wi-Fi network 300 might have a QR code associated with it, specifically for onboarding. The information for that QR code (associated with the guest device) can be entered into the account, and moved from the cloud down to the access points in the customer's home at that time. Then, when the device (e.g., Wi-Fi network 300) arrives at the home, it can immediately get on the Internet 12 when powered up, without a QR code having to be scanned.

This could be done by having the QR information displayed on the outside of the box, for example, and the information can be scanned at the time of filling the order at the store. It could also be done by having the information associated with the QR code scanned at the time of manufacture. Then, the information can be stored in a database indexed by the MAC address or other identifier for the device. In some embodiments, the QR code may be fetched from the database and loaded into the Wi-Fi network of choice when the consumer indicates they are trying to add a new device, when the new device appears and tries to onboard onto the network, or in other similar situations.

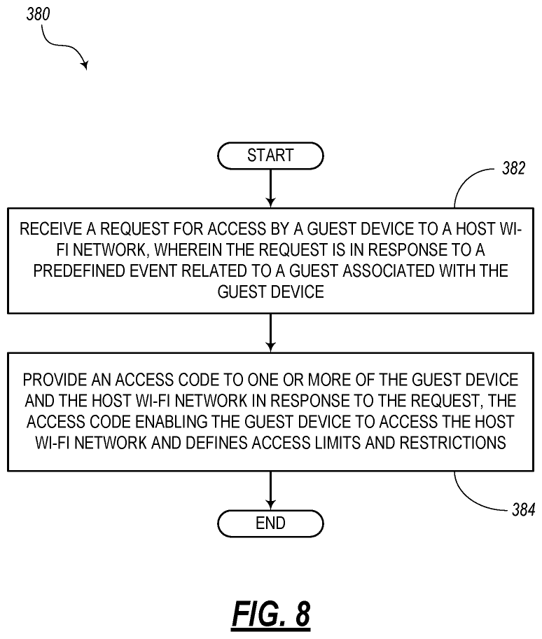

FIG. 8 is a flow diagram illustrating an embodiment of a process 380 for limiting guest access of a host Wi-Fi network. In this embodiment, the process 380 includes the step of receiving a request for access by a guest device to a host Wi-Fi network, wherein the request is in response to a predefined event related to a guest associated with the guest device, as indicated in block 382. The access code, for example, enables the guest device to access a host Wi-Fi network. The process 380 further includes the step of providing an access code to one or more of the guest device and the host Wi-Fi network in response to the request, the access code enabling the guest device to access the host Wi-Fi network and defines access limits and restrictions, as indicated in block 384.

In some embodiments, the process 380 may further include the step of receiving the predefined restrictions from a host associated with the host Wi-Fi system. For example, the predefined restrictions may limit a time limit for the guest based on parameters of the predefined event. The predefined restrictions may further limit the guest based on one or more predefined events, such as a) specific requests received from the guest and b) specific financial transactions associated with the guest.

The predefined event described in block 382 may include a) the host making a command on behalf of the guest, b) the guest making a request when the host Wi-Fi network is a publicly accessible network, c) the guest providing service subscription information, d) the guest providing membership information, e) the guest making a purchase, and/or other events. Also, the process 380 may further include the step of storing purchase information associated with the purchase.

The step of providing the access code (block 382) may include, according to some embodiments, a Quick Response (QR) code to be scanned by the guest device. According to various embodiments, the QR code may be presented on a) a closed-circuit television screen, b) a dedicated display device associated with a Point-of-Sale (POS) device, c) an electronic device associated with a host of the host Wi-Fi network, d) a receipt, and/or on other media.

The predefined event described with respect to block 382 may be a purchase using Near Field Communication (NFC) protocols. In this case, the step of providing the access code (block 382) may further include the step of automatically communicating the access code to the guest device during this NFC purchase. The process 380 may also include a step of also limiting the locations where the guest device can access the host Wi-Fi network.

Those skilled in the art will recognize the process 380 can be performed at various locations, in the cloud, on PoS devices, on an access point, in the Wi-Fi network, on a television, on a mobile device, on a Wi-Fi controller, and the like.

### Conclusion

It will be appreciated that some exemplary embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the exemplary embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various exemplary embodiments.

Moreover, some exemplary embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various exemplary embodiments.

The foregoing sections include headers for various embodiments and those skilled in the art will appreciate these various embodiments may be used in combination with one another as well as individually. Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A method comprising steps of:
receiving a request for access by a guest device to a host Wi-Fi network, wherein the request is in response to a predefined event related to a guest associated with the guest device, and
providing an access code to one or more of the guest device and the host Wi-Fi network in response to the request, the access code enabling the guest device to access the host Wi-Fi network and defines access limits and restrictions.

2. The method of claim 1, wherein the access code is provided to both the guest device and the host Wi-Fi network, wherein the guest devices utilizes the access code to access the host Wi-Fi network which utilizes the access code for the access limits and restrictions of the guest device.

3. The method of claim 1, wherein the steps further include
one or more of a visually displaying the access code on a display device, printing the access code via a printer code, and communicating the access code to the host Wi-Fi network,
wherein the guest device is configured to scan the access code provided either by the display device or the printer.

4. The method of claim 1, wherein the access limits include a time limit for the guest based on parameters of the predefined event.

5. The method of claim 1, wherein the restrictions further limit the guest based on one or more predefined events including at least one of specific requests received from the guest and specific financial transactions associated with the guest.

6. The method of claim 1, wherein the predefined event includes one or more of the host making a command on behalf of the guest, the guest making a request when the host Wi-Fi network is a publicly accessible network, the guest providing service subscription information, the guest providing membership information, and the guest making a purchase.

7. The method of claim 1, wherein providing the access code is presented as a Quick Response (QR) code to be scanned by the guest device.

8. The method of claim 7, wherein presenting the QR code includes displaying the QR code on one or more of a television screen, a dedicated display device, a Point-of-Sale (POS) device, and an electronic device associated with a host of the host Wi-Fi network.

9. The method of claim 7, wherein presenting the QR code includes displaying the QR code on one or more of a smart phone, tablet, or laptop.

10. The method of claim 7, wherein presenting the QR code includes displaying the QR code on one or more of a dedicated display device that connects to the host Wi-Fi network via Wi-Fi or Bluetooth.

11. The method of claim 1, wherein providing the access code is via communication using Near Field Communication (NFC) protocols.

12. The method of claim 1, wherein the access code conforms to one or more of EasyConnect and Device Provisioning Protocol.

13. The method of claim 1, wherein the access code includes one or more properties including changing over time, provided only on demand, valid for a short time period, and unique to each guest device.

14. The method of claim 1, wherein the access code includes a certificate or identifier that is loaded onto the guest device by the apparatus.

15. The method of claim 1, wherein providing the access code is via a picture and the guest device is configured to take a picture of the access code.

16. The method of claim 1, wherein the method is performed by a cloud management system that is connected to multiple host Wi-Fi networks.

17. The method of claim 1, wherein the host Wi-Fi network includes multiple access points, and the multiple access points coordinate which access point responds to the guest device.

18. The method of claim 1, wherein the restrictions limit locations where the guest device can access the Wi-Fi network.

19. The method of claim 1, wherein reception of the access code further enables a host to determine proof of physical access based on the access code.

20. The method of claim 1, wherein a host allows the guest device to serve as a chain of trust for subsequent guest devices.

21. The method of claim 1, in which access is provided to a Wi-Fi network located in a home, hotel, coffee shop, lobby, waiting room, conference, or shared office space.

22. A non-transitory computer-readable medium comprising instructions that, when executed, cause a processing device to perform the method of claim 1.
